(19) United States
(12) Patent Application Publication
(10) Pub. No.: US 2023/0278047 A1
(43) Pub. Date: Sep. 7, 2023

(54) HIGH PRESSURE FLUID ORBITAL SPRAY NOZZLE

(71) Applicant: STONEAGE, INC., Durango, CO (US)

(72) Inventor: Shawn LANGE, Durango, CO (US)

(21) Appl. No.: 18/118,586

(22) Filed: Mar. 7, 2023

Related U.S. Application Data
(60) Provisional application No. 63/317,435, filed on Mar. 7, 2022.

(51) Int. Cl. B05B 3/06; B08B 9/043

(52) U.S. Cl. CPC B05B 3/066; B08B 9/0433; B08B 2209/04

(57) ABSTRACT

A rotary nozzle assembly has a hollow nozzle body fastened to a high pressure hose, a tubular shaft rotatably carried in the hollow nozzle body, and a head member fastened to the tubular shaft. The head member has a rounded nozzle head portion and a threaded tubular portion and a central blind bore concentric with the central axis of the tubular shaft. The rounded nozzle head portion has a first lateral port passing from the central blind bore through a side of the rounded nozzle head portion at an offset from the central blind bore. This causes an unbalanced motion of the nozzle assembly on the high pressure hose while the tubular shaft rotates with the head member within the hollow nozzle body. This causes the rotary nozzle assembly, when inserted within a pipe, to follow an orbital path around the inside of the pipe.

### CROSS REFERENCE TO RELATED APPLICATION

This application claims the benefit of provisional U.S. Application No. 63/317,435 entitled “High Pressure Fluid Orbital Spray Nozzle” filed on Mar. 7, 2022, the technical disclosure of which is incorporated herein by reference in its entirety.

### BACKGROUND OF THE DISCLOSURE

The present disclosure is directed to high pressure fluid rotary nozzle systems. In particular, embodiments of the present disclosure are directed to a nozzle apparatus utilizing orbital motion of such rotary nozzles within sewer piping.

High pressure water jet cleaning devices utilizing reaction force rotary nozzles tend to rotate at very high speeds. In many applications, such as sewer cleaning operations it is desirable to slow down such rotary nozzle speed to maximize usable lifetime of the rotary nozzle and effectively improve the cleaning efficiency of such nozzles. A speed reducing device fastened to the rotating shaft of such rotary nozzles is often utilized to retard rotation of the nozzle. One such retarding mechanism has a series of bearings immersed in a viscous fluid within the housing and between end support bearings that are also immersed in the viscous fluid. Another exemplary conventional retarder is a Warthog WG-1 by Stoneage Inc. This retarder has end support bearings sandwiching a large diameter drag sleeve fastened to or integrally formed around the shaft in the housing instead of utilizing a series of bearings in the viscous fluid. These support bearings and the drag sleeve are immersed in the viscous fluid contained within the cylindrical housing. Together the support bearings and the retarding drag sleeve are contained between two shaft seals, sealing the shaft to the housing, and preventing escape of the viscous fluid. Thus the end support bearings and the drag sleeve in the WG-1 are immersed in viscous fluid and function together to retard the speed of the rotating nozzle.

Traction nozzles are used in sewer pipe lines and other piping systems to assist in pulling high pressure hose into the pipe to reach obstructions requiring removal. These traction nozzles have jet tips oriented at an angle rearward in order to generate thrust in the nozzle within the pipe to assist in pulling the hose through and along long stretches of pipe and around pipe bends. These nozzles have forward directed cutting jet tips and may also have laterally directed tips to ablate the obstructions encountered. However, the forward directed jet tips produce a force counter to the forward travel of the nozzle through the pipe. This counterforce hinders effective deployment of the high pressure hose and reduces the net pulling force produced by the traction nozzle on the high pressure hose. Nozzles utilized in sewer cleaning operations typically have heads that are much smaller than the inner diameter of piping systems they are required to clean, on the order of ⅓ to ¼ the diameter of the piping they are inserted into. Such sewer lines typically have inside diameters on the order of 5-10 inches. A high pressure nozzle for use in such sewer cleanout applications typically has an outside diameter of at most two to three inches and may be required to be pushed through hundreds of feet of sewer line. Hence powerful rearward directed traction nozzle tips are necessary.

Sewer lines often run beneath trees, shrubs and other growing plants. Thus the roots of such trees and shrubs can eventually find their way into and through joints in the sewer lines looking for nutrients. When a conventional traction nozzle reaches a sewer line blockage generated by a tangle of roots the forward and lateral cutting jet tips on such nozzles typically bore a path about the diameter of the nozzle head directly ahead through the blockage. The nozzle must then be retracted and repeatedly pushed through the tangle of roots in order to create enough of a passage through the mass for the sewer line to operate. However, these nozzles cannot completely clear the blockage in the line in a reasonable amount of time. As a result, repeated periodic cleanings are often needed in order to maintain the functionality of the sewer line. Thus there is a need for a nozzle that can be fed readily through such sewer lines, yet also facilitates complete removal of such root masses and other sewer line blockages.

### SUMMARY OF THE DISCLOSURE

An exemplary embodiment of a rotary nozzle assembly in accordance with the present disclosure achieves complete cleaning of root masses and other blockages of sewer lines with inside diameters up to four to five times the nozzle head diameter. This rotary nozzle assembly includes a generally hemispherical head with unbalanced lateral nozzle tip inserts such that the entire nozzle assembly moves around the inside diameter of the sewer pipe in an orbital fashion as it is pushed and pulled through the sewer line.

One embodiment of a nozzle assembly in accordance with the present disclosure includes a hollow nozzle body fastened to a high pressure hose and a tubular shaft rotatably carried in the hollow nozzle body. The tubular shaft has a central axis and a head member is fastened to the tubular shaft. The head member has a rounded nozzle head portion, a threaded tubular portion and a central blind bore concentric with the central axis of the tubular shaft. The rounded nozzle head portion has one port passing through a distal end of the rounded nozzle head portion from the central blind bore and a first lateral port passing from the central blind bore through a side of the rounded nozzle head portion at an offset from the central blind bore. As a result, high pressure fluid passing through the central blind bore and out of the head member through the one port and the first lateral port causes an unbalanced motion of the nozzle assembly on the high pressure hose while the tubular shaft rotates with the head member within the hollow nozzle body. This unbalanced motion causes the nozzle assembly and a portion of the high pressure hose attached to the nozzle assembly to translate or laterally move around within a confining space such as an interior of a pipe in an orbital fashion.

Preferably this orbital motion around and against an inside surface of a pipe into which the nozzle assembly is inserted as the head member rotates within the hollow nozzle body effectively ensures that the wall surface within the pipe is scoured of all material such as root debris and other obstruction materials that may be encountered as the nozzle assembly is pushed and pulled through the run of pipe. An axis of the first lateral port is preferably offset from the central axis of the tubular shaft in order to set up this orbital motion. The nozzle in accordance with the present disclosure preferably further includes a bearing in the hollow nozzle body rotatably supporting the tubular shaft and a drag sleeve rotor on the tubular shaft operable to limit rotational speed of the head member and tubular shaft in order to facilitate the orbital motion of nozzle assembly.

The one port passing through the distal end of the rounded nozzle head portion is utilized as a cutting port. As such, the shorter the standoff distance to debris or obstacle such as tree roots protruding into a pipe or pipe joint the better for effective debris removal. The presence of a lateral port causes the nozzle head portion to effectively move closer to the debris via the orbital motion of the entire nozzle assembly such that more effective cutting through the debris can be achieved.

In an alternative embodiment of a nozzle assembly in accordance with the present disclosure this orbital motion caused by the lateral port through the nozzle head causes the head to mechanically scrape and ablate material found on the inside of the constraining pipe as the nozzle assembly translates in an orbital manner around the inner surface of the pipe. In this embodiment a forward directed port, or cutting port may be omitted or unnecessary.

In one exemplary embodiment, the nozzle body is preferably fastened to the high pressure hose via an inlet hose barb having a threaded portion and a central passage through the barb and a plurality of tractor ports extending from the central passage rearwardly through the threaded portion. The rounded nozzle head portion of the head member preferably has a hemispherical shape. The tubular shaft is bearing supported within the hollow nozzle body and carries a speed retarding rotor coaxially aligned with the tubular shaft and the head member.

Another embodiment of a nozzle assembly in accordance with the present disclosure may include a second lateral port opposite the first lateral port passing from the central blind bore through the side of the rounded nozzle head portion. This second lateral port is at a different offset from the central blind bore than the offset of the first lateral port. In this embodiment the rounded portion of the head member has a hemispherical shape.

Another embodiment of a nozzle assembly in accordance with the present disclosure may be viewed as including a hollow nozzle body fastened to a high pressure hose, a tubular shaft rotatably carried in the hollow nozzle body, the tubular shaft having a central axis, and a head member fastened to the tubular shaft. This head member has a central blind bore concentric with the central axis of the tubular shaft and a threaded tubular portion around the central blind bore merging with a rounded nozzle head portion. The rounded nozzle head portion has one port passing through a distal end of the rounded nozzle head portion from the central blind bore and a first lateral port passing from the central blind bore through a side of the rounded nozzle head portion at an offset from the central blind bore.

A second lateral port passes from the central blind bore through an opposite side of the rounded nozzle head portion. This second lateral port either has a different port diameter, a different offset, or a different structure than the first lateral port such that high pressure fluid passing through the central blind bore and out of the head member through the one port and the first lateral port and the second lateral port cause an unbalanced motion of the nozzle assembly on the high pressure hose while the tubular shaft rotates with the head member within the hollow nozzle body. This unbalanced motion causes the nozzle assembly and a portion of the high pressure hose attached to the nozzle assembly to move or translate in an orbital fashion around the longitudinal axis of the hose.

This orbital motion is particularly useful when the nozzle assembly is inserted within a length of pipe. The nozzle assembly translates orbitally around and against an inside surface of the pipe into which the nozzle assembly is inserted as the head member rotates within the hollow nozzle body, without the nozzle assembly itself rotating relative to the high pressure hose.

The axis of the first lateral port is preferably offset from the central axis of the tubular shaft. The nozzle assembly preferably includes a bearing in the hollow nozzle body rotatably supporting the tubular shaft and a drag sleeve rotor on the tubular shaft operable to limit rotational speed of the head member and tubular shaft in order to facilitate the orbital motion of nozzle assembly.

An embodiment of the nozzle body is preferably fastened to the high pressure hose via an inlet hose barb having a threaded portion and a central passage and a plurality of tractor ports extending from the central passage rearwardly through the threaded portion. In this embodiment the rounded nozzle head portion has a hemispherical shape. The tubular shaft is bearing supported within the hollow nozzle body and carries a speed retarding rotor coaxially aligned with the tubular shaft and the head member. The second lateral port opposite the first lateral port passes from the central blind bore through the side of the rounded nozzle head portion and preferably is offset differently from the central blind bore than the first lateral port. Alternatively the second lateral port may have a different offset angle than an offset angle of the first lateral port.

An embodiment of a nozzle assembly in accordance with the present disclosure may be viewed as including a hollow nozzle body fastened to a high pressure hose, a tubular shaft rotatably carried in the hollow nozzle body, the tubular shaft having a central axis, and a head member fastened to the tubular shaft. This head member has a central blind bore concentric with the central axis of the tubular shaft, a threaded tubular portion around the central blind bore and merging with a rounded nozzle head portion. The rounded nozzle head portion has one port passing through a distal end of the rounded nozzle head portion from the central blind bore and a first lateral port passing from the central blind bore through a side of the rounded nozzle head portion at an offset from an axis of the central blind bore. When operated with high pressure fluid passing through the central blind bore and out of the head member through the one port and the first lateral port this causes an orbital unbalanced motion of the nozzle assembly on the high pressure hose while the tubular shaft rotates with the head member within the nozzle body.

Further features, advantages and characteristics of the embodiments of this disclosure will be apparent from reading the following detailed description when taken in conjunction with the drawing figures.

### DESCRIPTION OF THE DRAWINGS

FIG. 1 is longitudinal cross sectional view of an exemplary nozzle assembly in accordance with one embodiment of the present disclosure on a length of flexible high pressure hose.

FIG. 2 is an exploded view of the nozzle assembly shown in FIG. 1.

FIG. 3 is a transverse cross sectional view through the head member of the nozzle assembly shown in FIGS. 1 and 2.

FIG. 4 is an exploded view of a second embodiment of a nozzle head in accordance with the present disclosure showing a different arrangement of nozzle ports in accordance with the present disclosure.

FIG. 5 is a transverse cross sectional view through the head member of the nozzle assembly shown in FIG. 4 showing a second arrangement of nozzle ports in accordance with the present disclosure.

### DETAILED DESCRIPTION

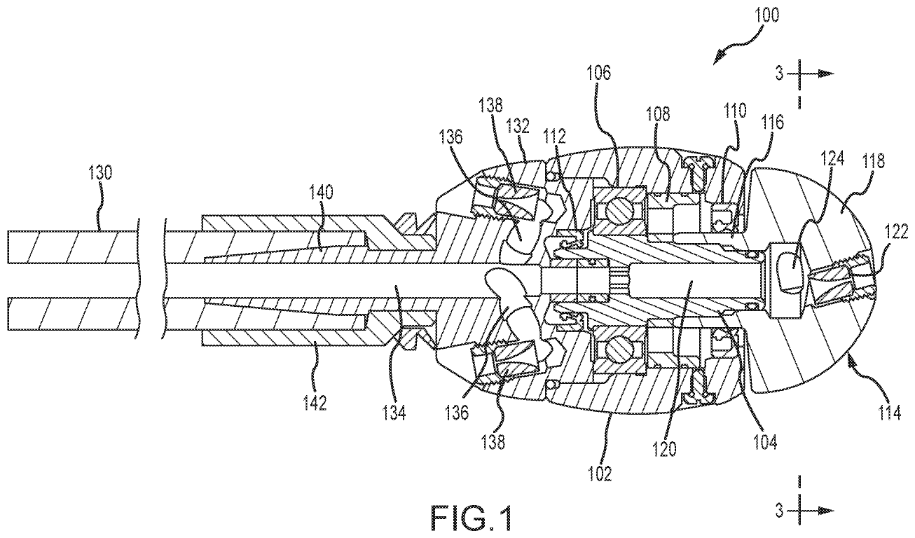

An exemplary first embodiment of an orbital high pressure spray nozzle assembly 100 in accordance with the present disclosure is shown in FIGS. 1, 2 and 3. Nozzle assembly 100 has a generally cylindrical hollow nozzle body 102 capturing therein a tubular shaft 104 which is rotatably supported in the nozzle body 102 by a bearing 106 and a drag sleeve rotor 108. The bearing 106 and drag sleeve roto 108 are sealed with the tubular shaft 104 by front and rear annular seals 110 and 112 around the tubular shaft 102. Space within the nozzle body 102 around the bearing 106 and rotor 108 is filled with a viscous fluid (not shown) to facilitate speed limited rotation of the tubular shaft 104. Fastened onto one end of the tubular shaft 102 is a head member 114. This head member 114 has a threaded tubular portion 116 which is threaded onto the tubular shaft 104. The tubular portion 116 of the head member 114 merges with a rounded head portion 118 that preferably has a generally hemispherical shape. The head member 114 has a central blind bore 120 passing through the tubular portion 116 and ending generally in the center of the rounded head portion 118.

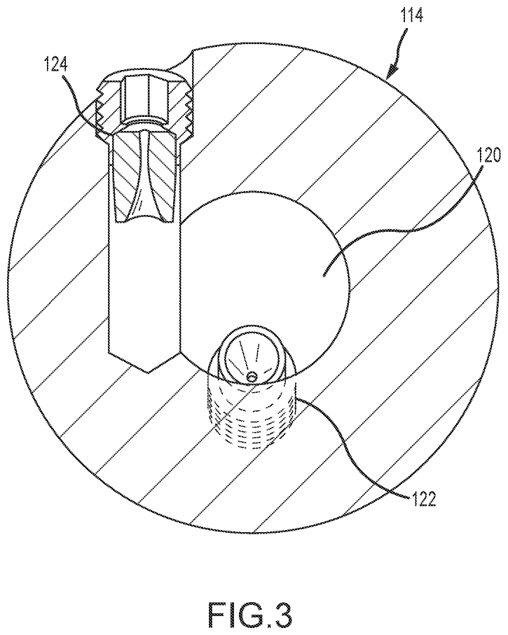

A single forward port 122 extends from the blind bore through the head portion 118 and out the distal end of the head member 114, preferably at a small angle to facilitate a selected spray angle pattern of high pressure fluid during rotation of the tubular shaft 104 and head member 114 for cleaning ahead of the nozzle assembly 100 during nozzle operation. A first side port 124 passes from the central blind bore 120 preferably laterally through a side of the head portion 118. This first side port 124 is preferably offset from a center of the central blind bore 120 as is shown in FIG. 3. The placement of this first side port 124 provides a rotational moment to the head member 114 as high pressure fluid is forced through the nozzle assembly 100 and out through the head member 114. This rotational moment spins the tubular shaft 104 and head member 114 about an axis through the nozzle body 102.

However, this spin moment about the axis through the nozzle body 102 by only a single lateral port 124 is geometrically lopsided such that the entire nozzle body 102 tends to translate about a longitudinal axis through a high pressure hose 130 attached to the nozzle assembly 100. As a result, at low rotational speeds such as would occur at relatively low fluid pressure, the entire nozzle assembly and attached hose 130 will tend to move in an orbital path around the longitudinal hose axis if the nozzle assembly were suspended by the hose. As operating pressure is increased, eventually this unbalanced movement of the nozzle assembly 100 and hose 130 reaches a point where the unbalanced movement becomes less than the rotational inertia of the nozzle head, beyond which the unbalanced motion is masked. In accordance with the present disclosure rotational speeds of the head member 114 are preferably limited to 400-800 rpm by the drag created by presence of the speed retarder rotor 108 on the rotating shaft 104.

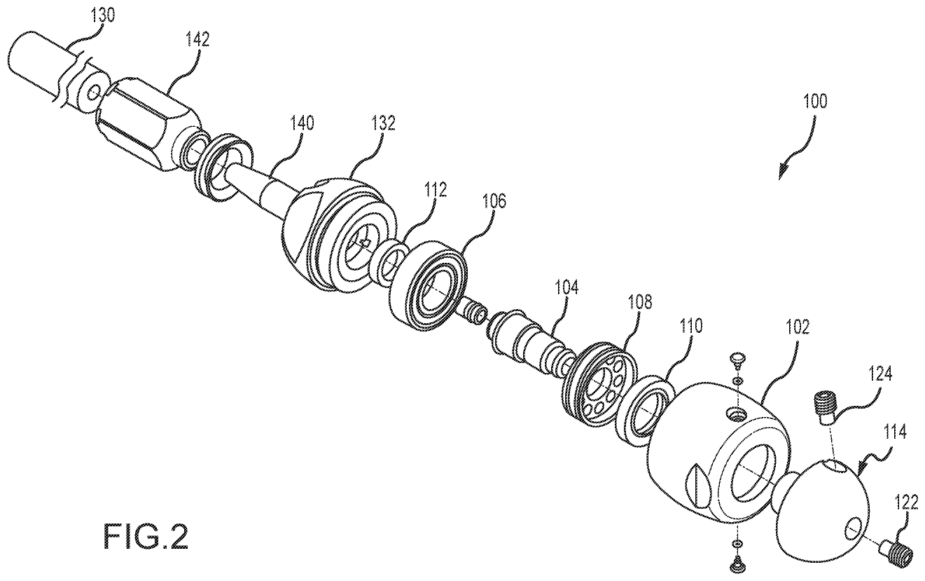

As is shown in FIGS. 1 and 2, in this exemplary embodiment 100 the nozzle body 102 is fastened to the hose 130 by an assembly made up of an inlet hose barb 132 which is threaded onto a rear and of the nozzle body 102. This inlet hose barb 132 has a central bore 134 and passages 136 to a plurality of rearwardly directed tractor ports 138 which, during operation, tend to pull the nozzle assembly 100 through any piping or conduit into which the assembly 100 is inserted. The inlet hose barb 132 has a tapered tubular barb portion 140 which is inserted into a distal end of hose 130. A conventional hose socket 142 is then threaded onto the barb portion 140 to capture the hose 130 to the barb 132 and hence to the nozzle body 102.

FIG. 3 is a transverse cross sectional view through head portion 118 taken along the line 3-3 in FIG. 1. Here you can see the port 124 is radially offset from the central blind bore 120. In addition, port 124 extends in a direction normal to the axis of the central blind bore 120.

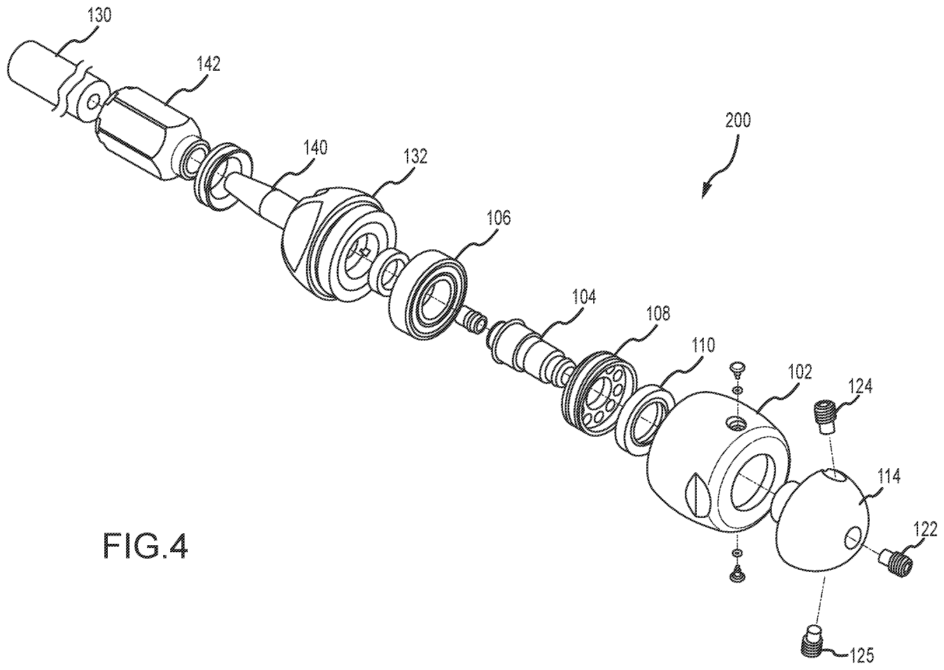

Turning now to FIG. 4, an exploded view of an alternative configuration of a nozzle assembly 200 is shown in accordance with the present disclosure. As in the first embodiment shown above, nozzle assembly 200 has a generally cylindrical hollow nozzle body 102 capturing therein a tubular shaft 104 which is rotatably supported in the nozzle body 102 by a bearing 106 and a drag sleeve rotor 108. The bearing 106 and drag sleeve roto 108 are sealed with the tubular shaft 104 by front and rear annular seals 110 and 112 around the tubular shaft 102. Space within the nozzle body 102 around the bearing 106 and rotor 108 is filled with a viscous fluid (not shown) to facilitate speed limited rotation of the tubular shaft 104. Fastened onto one end of the tubular shaft 102 is a head member 114. This head member 114 has a threaded tubular portion 116 which is threaded onto the tubular shaft 104. The tubular portion 116 of the head member 114 merges with a rounded head portion 118 that preferably has a generally hemispherical shape. The head member 114 has a central blind bore 120 passing through the tubular portion 116 and ending generally in the center of the rounded head portion 118.

A single forward port 122 extends from the blind bore through the head portion 118 and out the distal end of the head member 114, preferably at a small angle to facilitate a selected spray angle pattern of high pressure fluid during rotation of the tubular shaft 104 and head member 114 for cleaning ahead of the nozzle assembly 100 during nozzle operation. A first side port 124 passes from the central blind bore 120 preferably laterally through a side of the head portion 118. This first side port 124 is preferably offset from a center of the central blind bore 120 as is shown in FIG. 3. The placement of this first side port 124 provides a rotational moment to the head member 114 as high pressure fluid is forced through the nozzle assembly 100 and out through the head member 114. This rotational moment spins the tubular shaft 104 and head member 114 about an axis through the nozzle body 102.

However, in this second embodiment of a nozzle assembly 200 in accordance with the present disclosure a second lateral port 125 is installed in the rounded head portion 118 of the head member 114. This second lateral port 125, if placed symmetrically to the first lateral port 124, would counter the unbalanced moment on the head member 114 during nozzle operation. Therefore, in this second embodiment 200, the second lateral port 125 must be either differently offset from the axis of the blind bore 120, or have a different geometry or size or offset angle in order to achieve an unbalanced operating condition such that the entire nozzle assembly 100 or 200 tends to wobble or move in an orbital fashion as in the first embodiment described above.

As is shown in FIGS. 1 and 2, in this exemplary second embodiment 200, shown in an exploded perspective view in FIG. 4, the nozzle body 102 is fastened to the hose 130 by an assembly made up of an inlet hose barb 132 which is threaded onto a rear and of the nozzle body 102. This inlet hose barb 132 has a central bore 134 and passages 136 to a plurality of rearwardly directed tractor ports 138 which, during operation, tend to pull the nozzle assembly 100 through any piping or conduit into which the assembly 100 is inserted. The inlet hose barb 132 has a tapered tubular barb portion 140 which is inserted into a distal end of hose 130. A conventional hose socket 142 is then threaded onto the barb portion 140 to capture the hose 130 to the barb 132 and hence to the nozzle body 102.

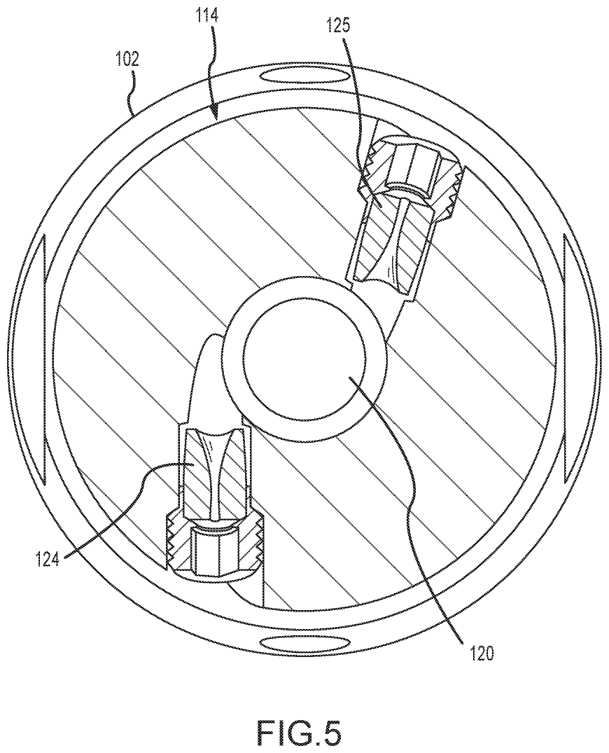

FIG. 5 shows a cross sectional view of the head member 114 similar to that shown in FIG. 3. However, in this head member 114 a second lateral port 125 is shown generally opposite that of port 124. This second nozzle port 125 is offset at a different angle from the blind bore 120 of the head member 114 such that the magnitude and directional moment developed by fluid exiting port 125 differs from that produced through lateral port 124. This arrangement produces an unbalanced moment about the entire nozzle assembly 200 such that the nozzle assembly 200 causes the connected hose and the nozzle 200 to follow an unbalanced or orbital path about a straight axis through both the hose 130 and the nozzle assembly 200. When such a hose and nozzle assembly is inserted into a pipe, the nozzle assembly 200 is constrained to move in an orbital fashion around the inside of the pipe, provided the speed of nozzle head member rotation is held below about 1000 rpm.

Many changes may be made to the embodiments described above. For example, instead of port 125 simply being provided at a different offset angle from the blind bore 120, the inner diameter of the port 125 may be different from that of port 124. Further, the offset distance from the blind bore 120 may be selected different from that of port 124. An additional third port could also be added to achieve a similar effect on the head member 114.

All such changes, alternatives and equivalents in accordance with the features and benefits described herein, are within the scope of the present disclosure. Such changes and alternatives may be introduced without departing from the spirit and broad scope of my invention as defined by the claims below and their equivalents.

What is claimed is:

1. A nozzle assembly comprising:
a hollow nozzle body fastened to a high pressure hose;
a tubular shaft rotatably carried in the hollow nozzle body, the tubular shaft having a central axis; and
a head member fastened to the tubular shaft, the head member having a rounded nozzle head portion and a threaded tubular portion, a central blind bore concentric with the central axis of the tubular shaft, the rounded nozzle head portion having one port passing through a distal end of the rounded nozzle head portion from the central blind bore and a first lateral port passing from the central blind bore through a side of the rounded nozzle head portion at an offset from the central blind bore, wherein high pressure fluid passing through the central blind bore and out of the head member through the one port and the first lateral port cause an unbalanced motion of the nozzle assembly on the high pressure hose while the tubular shaft rotates with the head member within the hollow nozzle body.

2. The nozzle assembly according to claim 1 wherein the unbalanced motion causes the nozzle assembly and a portion of the high pressure hose attached to the nozzle assembly to translate in an orbital motion around and against an inside surface of a pipe into which the nozzle assembly is inserted as the head member rotates within the hollow nozzle body.

3. The nozzle assembly according to claim 1 wherein an axis of the first lateral port is offset from the central axis of the tubular shaft.

4. The nozzle assembly according to claim 2 further comprising a bearing in the hollow nozzle body rotatably supporting the tubular shaft and a drag sleeve rotor on the tubular shaft operable to limit rotational speed of the head member and tubular shaft in order to facilitate the orbital motion of nozzle assembly.

5. The nozzle assembly according to claim 1 wherein nozzle body is fastened to the high pressure hose via an inlet hose barb having a threaded portion and a central passage and a plurality of tractor ports extending from the central passage rearwardly through the threaded portion.

6. The nozzle assembly according to claim 1 wherein the rounded nozzle head portion has a hemispherical shape.

7. The nozzle assembly according to claim 1 wherein the tubular shaft is bearing supported within the hollow nozzle body and carries a speed retarding rotor coaxially aligned with the tubular shaft and the head member.

8. The nozzle assembly according to claim 1 further comprising a second lateral port opposite the first lateral port passing from the central blind bore through the side of the rounded nozzle head portion.

9. The nozzle assembly according to claim 8 wherein the second lateral port is at a different offset from the central blind bore than the offset of the first lateral port.

10. The nozzle assembly according to claim 9 wherein the rounded nozzle head portion of the head member has a hemispherical shape.

11. A nozzle assembly comprising:
a hollow nozzle body fastened to a high pressure hose;
a tubular shaft rotatably carried in the hollow nozzle body, the tubular shaft having a central axis; and
a head member fastened to the tubular shaft, the head member having a central blind bore concentric with the central axis of the tubular shaft, a threaded tubular portion around the central blind bore merging with a rounded nozzle head portion, the rounded nozzle head portion having one port passing through a distal end of the rounded nozzle head portion from the central blind bore and a first lateral port passing from the central blind bore through a side of the rounded nozzle head portion at an offset from the central blind bore, and a second lateral port passing from the central blind bore through an opposite side of the rounded nozzle head portion, wherein high pressure fluid passing through the central blind bore and out of the head member through the one port and the first lateral port and the second lateral port cause an unbalanced motion of the nozzle assembly on the high pressure hose while the tubular shaft rotates with the head member within the hollow nozzle body.

12. The nozzle assembly according to claim 11 wherein the unbalanced motion causes the nozzle assembly and a portion of the high pressure hose attached to the nozzle assembly to translate in an orbital motion around and against an inside surface of a pipe into which the nozzle assembly is inserted as the head member rotates within the hollow nozzle body.

13. The nozzle assembly according to claim 11 wherein an axis of the first lateral port is offset from the central axis of the tubular shaft.

14. The nozzle assembly according to claim 12 further comprising a bearing in the hollow nozzle body rotatably supporting the tubular shaft and a drag sleeve rotor on the tubular shaft operable to limit rotational speed of the head member and tubular shaft in order to facilitate the orbital motion of nozzle assembly.

15. The nozzle assembly according to claim 11 wherein nozzle body is fastened to the high pressure hose via an inlet hose barb having a threaded portion and a central passage and a plurality of tractor ports extending from the central passage rearwardly through the threaded portion.

16. The nozzle assembly according to claim 11 wherein the rounded nozzle head portion has a hemispherical shape.

17. The nozzle assembly according to claim 11 wherein the tubular shaft is bearing supported within the hollow nozzle body and carries a speed retarding rotor coaxially aligned with the tubular shaft and the head member.

18. The nozzle assembly according to claim 11 wherein the second lateral port opposite the first lateral port passing from the central blind bore through the side of the rounded nozzle head portion is offset differently from the central blind bore than the first lateral port.

19. The nozzle assembly according to claim 18 wherein the second lateral port is at a different offset angle than an offset angle of the first lateral port.

20. A nozzle assembly comprising:
a hollow nozzle body fastened to a high pressure hose;
a tubular shaft rotatably carried in the hollow nozzle body, the tubular shaft having a central axis; and
a head member fastened to the tubular shaft, the head member having a central blind bore concentric with the central axis of the tubular shaft, a threaded tubular portion around the central blind bore merging with a rounded nozzle head portion, the rounded nozzle head portion having a first lateral port passing from the central blind bore through a side of the rounded nozzle head portion at an offset from an axis of the central blind bore, wherein high pressure fluid passing through the central blind bore and out of the head member through the one port and the first lateral port cause an orbital unbalanced motion of the nozzle assembly on the high pressure hose while the tubular shaft rotates with the head member within the nozzle body.
